(19) United States
(12) Patent Application Publication
(10) Pub. No.: US 2002/0071045 A1
(43) Pub. Date: Jun. 13, 2002

(54) Output method of different color channels of balanced color sensor

(76) Inventor: Shih-Huang Chen, Hsinchu (TW)

Correspondence Address: J C Patents Inc, 4 Venture Suite 250, Irvine, CA, 92618, US

(21) Appl. No.: 09/790,744

(22) Filed: Feb. 22, 2001

(30) Foreign Application Priority Data
Dec. 12, 2000 (TW) 89126419

(51) Int. Cl. H04N 5/335; H04N 3/14

(52) U.S. Cl. 348/312; 348/273; 348/296

(57) ABSTRACT

An output method of different color channels of a balanced color sensor, suitable for being applied to a color sensor comprising several color channels. Transmission gate signals within the same section of a phase signal corresponding to the above color channels are generated within different periods of time. In addition, the output times of these color channels can have a same midpoint, and shutter activation times with different lengths.

### BACKGROUND OF THE INVENTION

1. Field of the Invention

The invention relates in general to an output method of a color sensor. More particular, the invention relates to an output method of different color channels of a balanced color sensor.

2. Description of the Related Art

In a fax machine, copy machine or a scanner, the image conversion apparatus is used to convert visual images into electronic form for printing, storing, transmission or other electronic application. In image conversion apparatus, a photo-sensor, for example, a charge couple device (CCD) or a contact image sensor (CIS), is often used to perform the image detection. For color images, the sensor is commonly constructed based on an arrangement of a red, a green and a blue color CCD. After a period of time for exposure, the CCD transfers the induced charges to an analog shifter register to perform a post process.

Generally speaking, the light intensity and the CCD sensitivity are varied according to different systems. Furthermore, in each color channel (red, green and blue), the CCD sensitivity is different. The maximum and minimum intensities to be sensed by each CCD are also different. Therefore, to obtain a maximum value of signal-to-noise, by comparing the sense light with the noise, factors such as light intensity, the CCD exposure time, and the gain of the signal amplifier can be adjusted.

One of the conventional methods includes simply adjusting the shutter to obtain different exposure times for different color channels. In FIG. 1, a sequence drawing of such a technique is illustrated. In FIG. 1, sh1, sh2, sh3 represent the tip gate signals for three color channels. The signals, shutter1, shutter2, and shutter3, indicate the initial and terminal times of the shutter signals of these three color channels. The signals PH1 and PH2 are the phase signals used for the CCD. It can be seen from FIG. 1, although a better signal-to-noise ratio can be obtained due to different exposure times for each color channel, the exposure time of each color channel is concentrated in the last section. Therefore, an aberration is thus easily caused in this technique.

In the Taiwanese Patent No. 324076, “method of improving the signal-to-noise of the CCD sensor of a color display apparatus”, a method for adjusting the signal-to-noise ratio is provided. In this method, different exposure times are used for different color channels to maximize the signal-to-noise ratio. This method looks easy, however, is difficult to implement. For example, the transmission signal (SH) of the same color channel has periods with different lengths, that is, the pulse intervals of the transmission signal are variable, not constant. Therefore, it is difficult to design the phase signals, and the cost for designing the circuit of such a phase signal is greatly increased.

According to the above, the prior art has the following drawbacks:

1. Aberration is easily caused.

2. The circuit is difficult to design, and the cost for designing such a circuit is high.

### SUMMARY OF THE INVENTION

The invention provides an output method for different color channels of a balanced color sensor applied to a color sensor with several color channels. Transmission gate signals corresponding to different color channels are generated at different times. These transmission gate signals are located in the same section of a phase signal. In addition, the output periodof time for each of these color channels has the same midpoint, for shutter times with different lengths.

Using the method provided by the invention, the occurrence of aberration is alleviated. The circuit design is simpler and is suitable for use in current image sensing systems such as scanners.

Both the foregoing general description and the following detailed description are exemplary and explanatory only and are not restrictive of the invention, as claimed.

### BRIEF DESCRIPTION OF THE DRAWINGS

FIG. 1 shows a sequence diagram of a prior technique; and

FIG. 2 shows a sequence diagram of a method provided by the invention.

### DESCRIPTION OF THE PREFERRED EMBODIMENTS

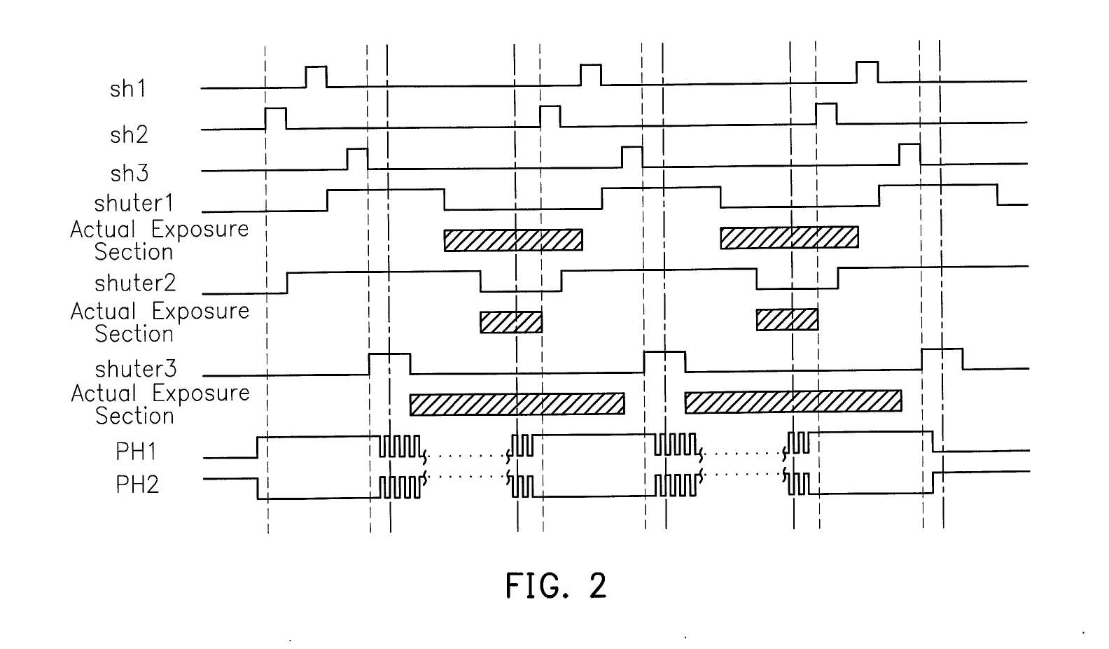

Referring to FIG. 2, an embodiment of a sequence diagram of a method provided by the invention is shown. Typically, a charge couple device is formed of several rows of CCD elements. Each row of CCD can detect a color. In the operation mode of a single row of CCD elements, when the voltage of the transmission gate signal (for example, sh1) varies once, the charges detected by the row of the CCD elements move to a shift buffer via the transmission gate. The charges in the shift buffer gradually shift to the analog-to-digital converter (ADC). The analog voltage signal caused by the charges is thus converted into a digital electronic signal.

When the voltage of the phase signal varies, the charges in the shift buffer shift according to the system design. Therefore, the charges in the row of CCD elements can only shift to the shift buffer via the transmission gate when there is no variation of the phase signal. In this embodiment, the transmission gate signals sh1, sh2 and sh3 are all generated in the section when the phase signal PH1 is high, and the phase signal PH2 is low (that is, there is no variation of voltage). The charges in each row of CCD elements can also shift to the shift buffer via the transmission gate. It is appreciated that the charges in the row of CCD elements move to the shift buffer when the phase signal PH1 is high in this embodiment. However, it is also possible to have the charges in the row of CCD elements move to the shift buffer when the phase signal PH1 is low.

In this embodiment, the transmission gate signals sh1, sh2 and sh3 of the rows of CCD elements are generated at different times. However, these transmission gate signals sh1, sh2 and sh3 are all generated in a section where the phase signal has the same voltage. Thus, the output frequency of the charges detected by the three color channels can be uniformly designed. After the voltage of each transmission gate is varied, the shutter is turned on for a period of time to eliminate the unwanted detected charges. Using the first color channel as an example, the transmission gate signal is sh1, and the phase signals are PH1 and PH2. The period of time for turning on the shutter is indicated by the signal shutter 1. The period of time for turning on the shutter is the time section from one rising edge and one descending edge. As shown in FIG. 2, the exposure section is the hatched area under the signal shutter1. Similarly, the exposure time for the second color channel is the hatched area under the signal shutter2, and the exposure time for the third color channel is the hatched area under the signal shutter3.

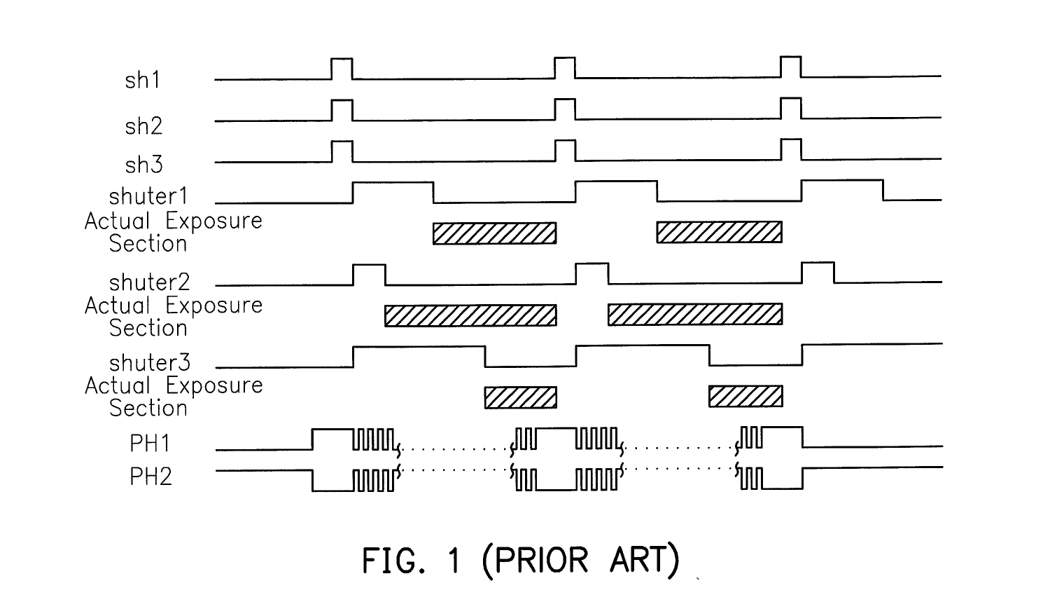

As the sensitivity of light intensity received by each row of CCD elements may vary, therefore, different lengths of exposure time for each row of CCD elements can thus gather the upper limit of the light intensity received by each row of CCD elements. In this invention, by generating the transmission gate signals (sh1, sh2, sh3) at different times and designing different lengths of shutter activation times, this objective can be achieved. In this embodiment, the actual overlap portion of the exposure time is closer to the middle section of the integral exposure time compared to the actual exposure time in FIG. 1. As a result, the occurrence of aberration can be suppressed. Although the middle line of the actual exposure time is the same in this embodiment, the invention is not limited to this restriction.

As the signal variation in this invention is not too great, only the time to keep the phase signal constant is lengthened, and the transmission gate signals are generated at different times. The circuit design is much easier, without a complex structure.

The invention thus has the follow advantages. Aberrations do not easily occur to the output method of different color channels of a balanced color sensor provided by the invention. The circuit design can also be simplified. It is thus suitable to be used in current image sensing systems.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An output method of different color channels of a balanced color sensor, suitable for use in a scanner with a plurality of color channels, the method generating a plurality of transmission gate signals at different times and corresponding to the color channels, wherein the transmission gate signals are in the same section of a phase signal.

2. The method according to claim 1, wherein the color channels have different lengths of time for turning on a shutter.

3. The method according to claim 1, wherein each of the color channels has an output time, and the output time of all the color channels has the same midpoint.
